(19) United States
(12) Patent Application Publication
(10) Pub. No.: US 2017/0265450 A1
(43) Pub. Date: Sep. 21, 2017

(54) BAIT STATION

(71) Applicant: TRINROX PTY LTD, VICTORIA (AU)

(72) Inventors: DAVID GRAHAM PRIDDY, VICTORIA (AU); TIMOTHY JAMES GORDON, VICTORIA (AU)

(73) Assignee: TRINROX PTY LTD, VICTORIA (AU)

(21) Appl. No.: 15/505,441

(22) PCT Filed: Aug. 21, 2015
(86) PCT No.: PCT/AU2015/000503

§ 371 Date: Feb. 21, 2017

(30) Foreign Application Priority Data
Aug. 22, 2014 (AU) 2014903319

(51) Int. Cl. A01M 1/20; B32B 37/12; B32B 7/12; B32B 27/32; A01M 25/00; A01M 1/02

(52) U.S. Cl. CPC A01M 1/2011; A01M 25/002; A01M 1/02; B32B 7/12; B32B 27/32; B32B 37/12; B32B 2323/10

(57) ABSTRACT

A planar bait presenting device is described comprising a bait contact zone for receiving bait wherein the bait contact zone comprises a dose measurement guide and an ink display zone. A kit is also described comprising a plurality of the bait presenting devices and a backing sheet to which the devices are removably adhered. A method of displaying bait, is described which comprises adhering the device to a surface; and applying a discrete amount of bait to the bait contact zone. The method involves applying bait to the bait contact zone until the area defined by the dose measurement guide is substantially covered with bait. Also described are methods of displaying bait which comprise adhering the device to a surface and exposing a discrete amount of bait in the bait contact zone; and methods of enclosing bait in a hole which comprise inserting a discrete amount of bait into a hole and adhering the device to the surface surrounding the hole, thereby enclosing the bait in a hole.

### FIELD OF THE INVENTION

The present invention relates to devices and methods for a bait station. In particular, the present invention relates to bait stations that are suitable for crawling insects, rodents and the like. More specifically, the present invention relates to bait stations that are suitable for insects such as cockroaches, ants and/or termites.

### BACKGROUND OF THE INVENTION

Infestations of pests including crawling insects, such as ants, termites and cockroaches, are typically treated by placing poisonous bait around or near to the insect nest or in the area where the insects gather food. The bait used is typically a viscous substance or aqueous-gel mixture which includes an attractant, a food source such as, a sugar or a carbohydrate solution, and a toxin. The bait may also include preservatives and colorants.

Various devices, referred to as bait stations, have been used to present the bait to crawling insects. The majority of these devices make use of a sealable container which provides a plurality of access holes to allow the crawling insects to enter the interior of the container and feed on the poisonous bait, as well as to share the bait with other insects through insect-insect contact. When used to treat ant and/or cockroach infestations, these bait stations are often positioned in areas of food preparation, such as in kitchens, under refrigerators and the like. Monitoring any reduction in the amount of bait indicates not only the presence of insects that are consuming the bait, but also whether the bait is effective in attracting the insects and killing them. Over time, the bait needs to be topped up or replaced. Often such bait stations are manufactured as disposable containers, and a user simply replaces the bait station with a new one.

Many bait stations are relatively large and unattractive, and in order to conceal their presence they are often manufactured in black plastic. This makes such bait stations difficult to find again when it is time to dispose of them. Furthermore, as the bait station is usually sealed for safety reasons, it is often difficult to see inside the bait station and monitor whether the bait in the bait station has been consumed by insects, and/or whether the bait station needs to be replaced. Many bait stations also employ a tacky, exposed surface to display or present the food source in the bait to the insects. Such tacky surfaces typically build up debris from dust and dead insects adsorbed/attached to the surface which in turn can block a large portion of the bait surface from access by target insects, reducing its effectiveness.

Bait may be presented directly to insects in the form of a bait gel, such as Maxforce™ Gold Cockroach Bait (Bayer), which is daubed directly onto a surface that is frequented by the target insects, such as the upper surface of cupboard door hinges, as shown in FIG. 1. Bait gels are usually applied by professional pest eradication service providers. The bait gel is provided in an applicator tube with a nozzle applicator, which is squeezed against a surface, toothpaste fashion. Due to its viscous nature, bait gel is usually placed on horizontal or vertical surfaces. As the bait gel is exposed and visible, a user can monitor any consumption of bait gel, and the presence of any dead target insects, to establish the effectiveness of the bait gel in both attracting the insects and in killing them.

Daubed bait gel is often unattractive in appearance and once consumed by pests it is difficult to identify where treatments have been made. The application of such bait gels can also leave unsightly stains and residues on various surfaces, causing damage to the furniture and equipment on which it is placed. It can be inadvertently removed by cleaning personnel who mistake it for dirt and grime. Furthermore, a user may forget where the bait gel was previously applied, and may be unable to determine whether or not it has been removed. This makes it difficult for a user to monitor any consumption of bait gel or to establish the effectiveness of the bait gel.

The amount or dose of bait gel to be applied to a surface is difficult to measure when squeezing the bait gel from the applicator tube resulting in the application of inaccurate, inappropriate and non-uniform doses. Not only can this result in inaccurate, excessive application of the bait gel and waste, or insufficient application of the bait gel, but the non-uniform manual application of the gel makes it difficult for a user to record the starting dose so as to monitor any later consumption of bait gel.

Since many insects causing infestations in domestic or commercial areas are nocturnal, it is not always apparent whether an infestation in fact exists. It is undesirable to use toxic bait in circumstances when it is not yet clear whether an infestation exists requiring treatment. In using the above-mentioned methods and devices for monitoring potential consumption of bait by possible insects, a user is forced to apply toxic bait in areas where food is prepared for consumption by humans.

The present invention seeks to provide a device and/or method that will alleviate one or more of the shortcomings of currently available bait stations and their use.

### SUMMARY OF THE INVENTION

Broadly, the invention is directed to a substantially planar bait presenting device comprising a bait contact zone and an ink display zone.

According to a first aspect of the invention there is provided a substantially planar bait presenting device comprising a bait contact zone for receiving bait wherein the bait contact zone comprises a dose measurement guide; and an ink display zone.

The bait contact zone and the ink display zone may be adjacently disposed on an adherent sheet comprising a printable sheet and an adherent layer.

The adherent layer may be a non-permanent adherent layer. The adherent layer may be disposed on the upper or lower surface of the adherent sheet. The adherent layer may be configured to form an adhesive ring disposed adjacent to the perimeter of the adherent sheet. Preferably, the adherent layer comprises a non-permanent adhesive or electrostatic film, such as that known as micro suction technology. In use, a non-permanent adherent layer permits removal of the adherent sheet from a surface leaving no or minimal adherent layer residue on the surface. The removed adherent sheet may be reapplied to the same or another surface. In certain embodiments, the adherent layer allows the device, in use, to be removable and/or repositionable.

The printable sheet may comprise a plastic polymer such as a polypropylene material. In use, the printable sheet is typically robust to permit the removal of the entire adherent sheet without tearing. The printable sheet may be transparent.

The bait contact zone may be a zone for receiving bait. It may comprise a dose measurement guide marked on the device by way of printed lines demarcating an area on an operative upper surface of the adherent sheet. The dimensions of the dose measurement guide may be configured to receive a predetermined dose of bait. The dose measurement guide may comprise indicia defining an area corresponding to a predetermined dose of bait. The area corresponding to the predetermined dose of bait may be the cross-sectional area of a bait volume of the predetermined dose of bait when applied to the device. The amount of bait to be applied to the bait contact zone may be described in the product label directions. It will be appreciated that the dose measurement guide may comprise a graduated series of printed lines demarcating a series of areas, each area corresponding to the predetermined dose of bait.

The indicia defining the area on the dose measurement guide which correspond to a predetermined dose of bait may comprise a wholly or partially raised perimeter which substantially defines a well for receiving bait. This wholly or partially raised perimeter may be formed by a layer of ink or pigment, or the like, applied to an operative upper surface of the device.

The bait contact zone may be a zone for enclosing a hole. It may be located on an operative lower surface of the device. The dimensions of the dose measurement guide may correspond with the shape and dimensions of the hole, preferably a drilled hole.

The ink display zone may comprise visual indicia. The visual indicia may comprise ink or pigment such as fluorescent ink or pigment detectable by light which induces fluorescence of the ink, such as, but not limited to, actinic light covering all or part of the visible and ultra-violet spectrum, ultra-violet or black light. The fluorescent ink or pigment may not be visible to the human eye in daylight. The fluorescent ink or pigment may be the ink known as Offset 3NY Colourless FLOU blue from Sicpa Holding SA.

The ink display zone may be positioned adjacent to the perimeter of the adherent sheet. Preferably, the ink display zone is configured in a ring shape and is positioned adjacent to the perimeter of the adherent sheet.

It will be appreciated that the device may be any practical shape which does not compromise its function. The device may be substantially circular with a diameter ranging from about 15 mm to 50 mm. Preferably, the device is 25 mm in diameter. The device may be elongate, with a length of between about 15 mm and 100 mm and a width of between about 10 mm and 50 mm. Preferably, the device is about 80 mm in length and about 25 mm in width.

It will also be appreciated that the bait contact zone may be shaped to form any suitable shape such as but not limited to, an linear, elongate strip, an elongate wave or a zig-zag.

In a first embodiment of the invention, the bait contact zone is substantially circular with a diameter ranging from about 5 mm to 25 mm. Preferably, the bait contact zone is 5 mm in diameter.

In a second embodiment of the invention, the bait contact zone is elongate. In this embodiment, the length of the bait contact zone may be between about 5 mm and 100 mm and the width may be between about 1 mm and 10 mm. Preferably, the bait contact zone is about 75 mm in length and about 4 mm in width.

The bait contact zone may be placed near the middle or centre of the adherent sheet. Preferably, the bait contact zone is placed in the middle or centre of the adherent sheet, and is circumscribed by a ring-shaped ink display zone.

The adherent sheet may further comprise at least one labelling zone. The labelling zone may comprise a layer of ink or pigment that is visible in daylight. Trade Marks or brand logos may be applied to, or printed on, the labelling zone. The labelling zone may comprise instructions, warnings, or dose guide information relating to the bait contact zone. The labelling zone may overlap with, or be integral with, the ink display zone. The labelling zone may comprise visual indicia comprising information relating to the bait.

The labelling zone may comprise a surface suitable for displaying handwritten indicia comprising information relating to the use of the device. For example, such information may comprise the date, time and/or location of bait application, the identity of the user using the device, and/or the nature and dose of the bait applied.

In a third embodiment of the invention, the adherent sheet of the device comprises a labelling zone which is integral with the ink display zone.

The device may further include bait. Typically, the bait contains pesticide. The bait may be in the form of bait gel. The bait may be provided in a predetermined dose.

Bait used in the art may be used, such as Maxforce™ Gold Cockroach Bait (Bayer), Maxforce™ White (Bayer), Goliath Cockroach Gel (BASF), Advion™ Gel (Syngenta), Barmac™ Scuttle Gel (Barmac). For example, a predetermined dose of about 0.1 g 0.5 g of Maxforce™ Gold Cockroach Bait may be included in the device. The bait may be covered by a film layer.

The bait may be in the form of a solid bait. The bait may be provided in a predetermined dose. Bait used in the art may be used, such as Maxforce™ Complete Granule (Bayer), Amdro Ant Granules (BASF) or similar hard bait that insects such as ants and cockroaches can feed on. For example, a predetermined dose of 0.1 g of Maxforce™ Complete Granules may be included in the device. The bait may be covered by a film layer. The bait may be in the form of a dry powder or granular particulate composition. The dried bait may be mixed with an adherent layer to adhere the dried bait to the bait contact zone.

The bait may be in the form of a dust or powder, such as that typically used to treat a termite infestation.

In a fourth embodiment of the invention, the device is substantially circular with a bait contact zone of 5 mm in diameter which comprises a predetermined dose of bait gel, positioned substantially in the centre of the bait contact zone.

The device may further comprise a tab. The tab may be contiguous with the adherent sheet, and may be shaped and dimensioned for gripping by hand, such that the device may be removed from a surface to which it is adhered. Preferably, the tab is spaced apart from the bait contact zone.

In a fifth embodiment of the invention, the device comprises a rounded tab, shaped and dimensioned to be gripped between the forefinger and thumb of a user and configured to provide sufficient grip to remove the device from a surface to which it is adhered.

In a sixth embodiment of the invention, the bait contact zone of the device is located on the operative lower surface of the adherent sheet and is shaped and dimensioned to cover a hole, such as a drilled hole. The bait contact zone may be integral with the adherent layer. Alternatively, the bait contact zone is circumscribed by a ring-shaped adherent layer. This embodiment of the invention is typically used together with a dust or powder form of bait, such as that typically used to treat a termite infestation.

According to second aspect of the invention, there is provided a kit comprising a plurality of bait presenting devices according to the invention, and a backing sheet to which the devices are removably adhered.

In a seventh embodiment of the invention, there is provided a kit comprising a plurality of bait presenting devices according to the invention, the plurality of bait presenting devices adhered to a backing sheet in a continuous strip. The strip is packed as a compact roll, and dispensed from a box, such as a cardboard box, in the typical adherent sheet fashion.

In a eighth embodiment of the invention, there is provided a kit comprising a plurality of bait presenting devices according to the invention, the plurality of bait presenting devices adhered to a series of backing sheets. The stacked series of backing sheets is packed in a box, such as a cardboard box.

According to a third aspect of the invention, there is provided a method of displaying bait, the method comprising the steps of:
adhering a device according to the invention to a surface; and
applying a discrete amount of bait to the bait contact zone.

The step of applying a discrete amount of bait to the bait contact zone may comprise applying the bait until the area defined by the dose measurement guide is substantially covered with bait.

The step of applying a predetermined dose of bait gel to the bait zone of the device may comprise applying a predetermined dose of bait gel, such Maxforce™ Gold Cockroach Bait (Bayer), Maxforce™ White (Bayer), Goliath Cockroach Gel (BASF), Advion™ Gel (Syngenta), Barmac™ Scuttle Gel (Barmac). For example, a predetermined dose of 5 mm (0.1 g) of Maxforce™ Gold Cockroach Bait may be applied to the device.

According to a further aspect of the invention, there is provided a method of displaying bait, the method comprising the steps of:
adhering a device according to the invention to a surface; and
exposing a discrete amount of bait in the bait zone.

The step of exposing a discrete amount of bait on the bait zone of the device may comprise removing a film layer to expose a predetermined dose of bait. For example, a film layer may be removed to expose a predetermined dose of 5 mm (0.1 g) of Maxforce™ Gold Cockroach Bait. Alternatively, a film layer may be removed to expose dried bait in the form of a powder or granular particulate composition.

According to a further aspect of the invention, there is provided a method of enclosing bait in a hole, the method comprising the steps of:

inserting a discreet amount of bait into a hole; adhering a device according to the invention to a surface surrounding the hole, thereby enclosing the bait in the hole.

The step of adhering the device according to the invention to a surface may be repeated to adhere a plurality of devices to one or more surfaces.

The bait typically contains pesticide. The bait may be in the form of a bait gel or a solid bait.

The invention extends to a device when used in a method according to the invention.

The amount of bait applied to the bait contact zone may be according to the amount described in the product label directions.

It will be appreciated that while the devices and methods described herein may be used for crawling insects such as cockroaches, ants and termites, they may also be used for other pests such as silverfish, clothes moths, carpet beetles, litter beetle (darkling beetle), wasps such as the European wasp and flies.

### BRIEF DESCRIPTION OF THE DRAWINGS

The invention will now be described, by way of example only with reference to the accompanying representations in which:

FIG. 1 is a set of photographs showing the application of a bait gel for cockroaches directly to the surface of a metal cabinet and to the surface of cupboard door hinge, according to the method of the prior art;

FIG. 2 is a cross-section of a diagrammatic representation of the bait presenting device according to a first embodiment of the invention;

FIG. 3 is a diagrammatic representation of the bait presenting device according to a first embodiment of the invention (A), and according to a second embodiment of the invention (B);

FIG. 4 is a diagrammatic representation of the bait presenting device according to the invention in a variety of shapes (A to G), and incorporating a labelling zone according to a third embodiment of the invention (H and I);

FIG. 5 is a diagrammatic representation of the bait presenting device according to a first embodiment of the invention to which bait gel has been applied according to the method of the invention;

FIG. 6 is a diagrammatic representation of how the bait presenting device according to a fifth embodiment of the invention which is shown in FIG. 3(B) and FIG. 5 is removed by a user;

FIG. 7 is a diagrammatic representation of the bait presenting device according to a sixth embodiment of the invention;

FIG. 8 is a diagrammatic representation of the kit according to a seventh embodiment of the invention; and

FIG. 9 is a diagrammatic representation of the kit according to an eighth embodiment of the invention.

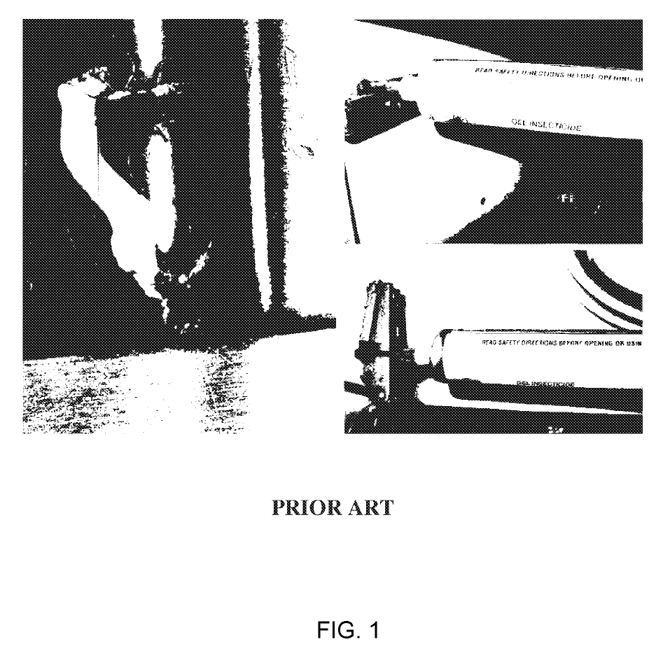

### DETAILED DESCRIPTION OF THE INVENTION

### EXAMPLE 1

The present invention relates to devices and methods for an insect bait station for use in treating infestations of insects such as cockroaches, ants, and/or termites.

Briefly, the bait station of the invention uses adherent sheet technology to display bait for insects by providing a surface for receiving bait gel and/or providing a marked guide for measuring the dose of bait gel applied. The adherent sheets may be used in conjunction with commercially available bait gels, and are typically applied by a user to surfaces in an area of insect infestation, such as a domestic or commercial kitchen, on surfaces frequented by the target insects. The user then applies a dose of bait gel to the adherent sheet, optionally using a marked guide printed on the adherent sheet. The fluorescent ink in the adherent sheet is typically detectable by ultra violet light or “black light” and the like, so that a user can quickly and easily detect where the adherent sheets have been applied by shining a black light torch in the area in the dark. Any consumption and/or effectiveness of the bait gel may be monitored over time by regular assessment of the bait gel remaining on the adherent sheets, and by noting the number and location of any dead insects.

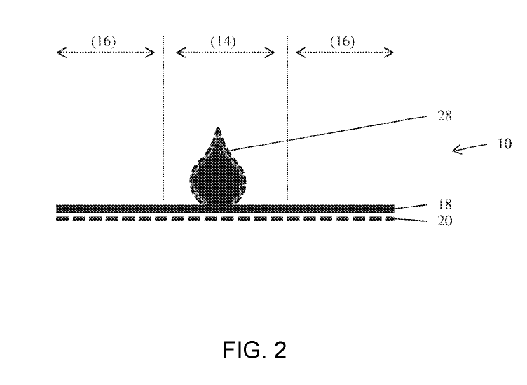

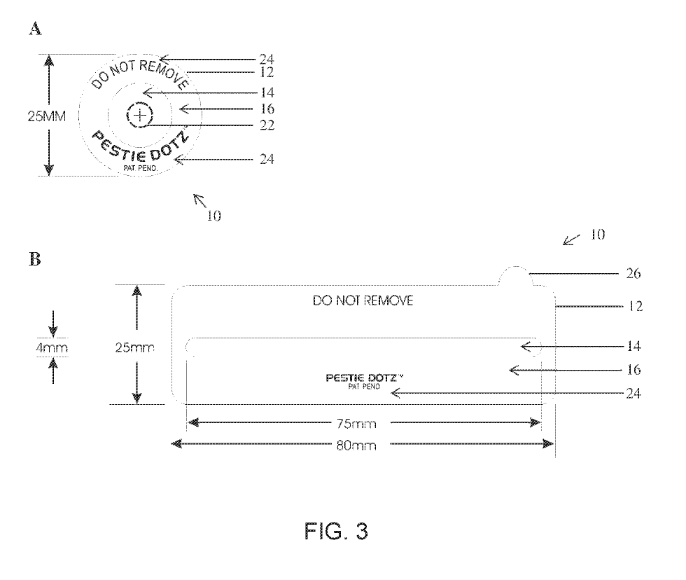

Referring to FIGS. 2 and 3A, a first embodiment of the invention provides a substantially planar bait presenting device (10) in the form of a substantially circular adherent sheet comprising an adherent sheet (12) having a bait contact zone (14) and an ink display zone (16). The adherent sheet is about 25 mm in diameter. The adherent sheet comprises a printable sheet (18) which is made from a robust plastic polymer such as a polypropylene material, and an adherent layer (20), such as electrostatic film. The adherent layer (20) is usually a non-permanent adherent layer.

The bait contact zone (14) is marked by way of printed lines or indicia on the adherent sheet, to provide a dose measurement guide (22), for example by printing a dotted line to indicate a droplet size, and a centre cross for aligning the application of the bait. The bait contact zone (14) may be shaped to form a linear, elongate strip. It will be appreciated that the bait contact zone (14) may be provided in any shape such as, but not limited to, an elongate wave or zig-zag. The indicia define an area corresponding to a predetermined dose of bait. That is, the area corresponding to the predetermined dose of bait is the maximum cross-sectional area of a liquid volume of the predetermined dose of bait when applied to the device (10). The dose measurement guide (22) comprises a wholly or partially raised perimeter which substantially defines a well for receiving bait (not shown).

The dimensions of the printed lines of the measurement guide (22) correspond with the size of a predetermined droplet dose of bait gel. In this embodiment, the bait contact zone (14) is substantially circular with a diameter of about 5 mm. The bait contact zone (14) is positioned near the middle or centre of the adherent sheet (12).

The ink display zone (16) is a zone of the adherent sheet to which a layer of fluorescent ink or pigment may be applied to form visual indicia. The fluorescent ink or pigment is only detectable by light which induces fluorescence of the ink, such as ultra-violet or black light. The ink display zone (16) is configured in a ring shape and is positioned adjacent to the perimeter of the adherent sheet (12), circumscribing the bait contact zone (14).

In this embodiment, the adherent sheet (12) further comprises two labelling zones (24). The labelling zones (24) comprise a layer of ink or pigment that is visible in daylight, and are printed with Trade Marks and/or brand logos, instructions, and/or warnings. The labelling zone (24) of this embodiment overlaps with, and is integral with, the ink display zone (16).

In use, a plurality of bait presenting devices (10) or adherent sheets are applied to various surfaces in an area of insect infestation, such as a domestic or commercial kitchen to display bait. The adherent sheets are usually applied or adhered to the external surfaces of cupboards, fridges, dishwashers, and sinks, as well as the interior of cupboards and the surfaces in the spaces between cupboards and equipment. The adherent sheets are typically applied to horizontal and vertical surfaces. Due to the non-permanent adherent layer (20) of the adherent sheets, they may be easily removed and repositioned without causing damage to the surface to which they are adhered, or leaving residue on it. The printable sheet (18) is also sufficiently robust to permit the removal of the entire adherent sheet without tearing, so that it can be discarded, reapplied, or repositioned.

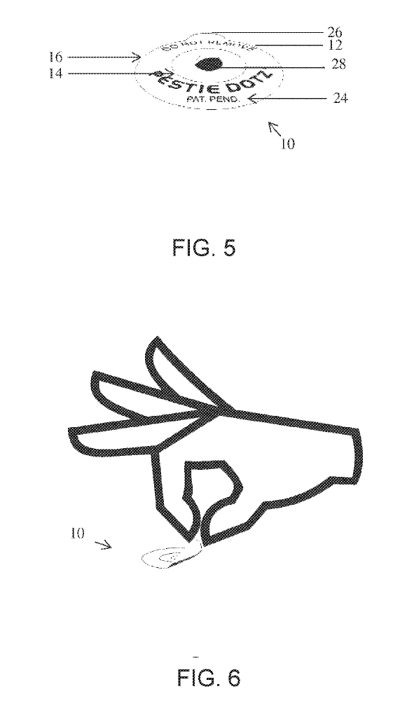

Once the adherent sheet has been applied to the target surface, the user applies a discrete amount of bait to it, usually in the form of bait gel, such as, but not limited to Maxforce™ Gold Cockroach Bait (Bayer). A droplet of bait gel (28) is squeezed from the applicator onto the cross of the measurement guide (22) until the edge of the droplet of bait gel reaches the dotted circle of the measurement guide (22). That is, the discrete amount of bait (28) is applied to the bait contact zone (14) until the area defined by the dose measurement guide (22) is substantially covered with bait (28). The size of the droplet of bait gel thus corresponds with a predetermined dose of 5 mm (0.1 g) of the bait gel, as shown in FIG. 5. This step is repeated to apply bait gel to all of the adherent sheets.

### EXAMPLE 2

Referring to FIGS. 2 and 3B, a second embodiment of the invention provides a bait presenting device (10) in the form of a rectangular adherent sheet comprising an adherent sheet (12) having an elongate bait contact zone (14) and an elongate ink display zone (16). The adherent sheet is about 80 mm in length and about 25 mm in width. The measurement guide (22) of the elongate bait contact zone (14) is marked by a printed strip to indicate a gel tube size. The dimensions of the printed lines of the measurement guide (22) correspond with the size of a predetermined tube dose of bait gel. The ink display zone (16) of this embodiment is configured to form two strips which are joined at their respective ends and is positioned adjacent to the perimeter of the adherent sheet (12), on either side of the elongate bait contact zone (14). The elongate bait contact zone (14) in this embodiment is about 75 mm in length and about 4 mm in width. This embodiment may be used in conjunction with ant gel products such as Advion™ Ant Gel (DuPont™) which requires a line of bait to be applied to the device for the treatment of heavy infestations of ants in order to maximise the amount of bait displayed.

In this embodiment, the adherent sheet also has a rounded tab (26), which is contiguous with the adherent sheet (12), and is shaped and dimensioned for gripping by hand. The tab (26) comprises an adherent layer and is spaced from the bait contact zone (14).

In use, the bait presenting devices (10) are applied to various surfaces in the same manner as described for Example 1. A user then applies bait gel to the adherent sheets by squeezing a tube of bait gel (28) from the applicator onto the bait contact zone (14) along the strip of the measurement guide (22), matching the size of the tube of bait gel with the dimensions of the strip of the measurement guide (22) as closely as possible. This step is repeated to apply bait gel to all of the adherent sheets.

When applying or removing the adherent sheets to a surface, a user typically grips the tab (26) as shown in FIG. 6. The tab (26) is spaced from the bait contact zone (14) so that a user can safely remove and dispose of a adherent sheet to which bait gel has been applied, without getting the bait on his or her fingers.

### EXAMPLE 3

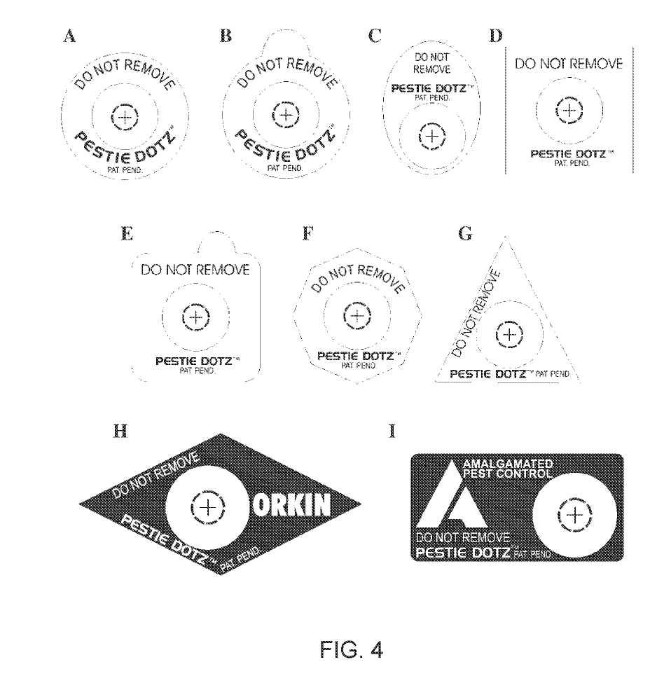

FIG. 4 shows bait presenting devices according to the invention in a variety of shapes (A to G), and incorporating a labelling zone according to a third embodiment of the invention (H and I).

### EXAMPLE 4

Another embodiment of the invention provides a bait presenting device (10) similar to that described in Example 2, to which bait has already been applied to the bait contact zone (14). This embodiment has a film (not shown) covering the bait.

In use, the device (10) is adhered to a surface in a similar manner to that described for Example 2. The user then pulls the film away, thereby exposing a discrete amount of bait in the bait contact zone (14).

### EXAMPLE 5

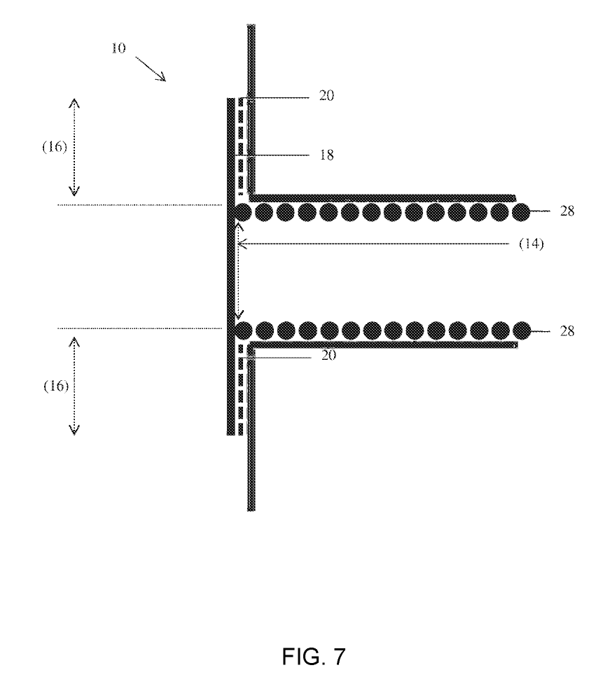

Referring to FIG. 7, a sixth embodiment of the invention provides a bait presenting device (10) in the form of an adherent sheet comprising an adherent sheet (12) having a bait contact zone (14) located on the underside of the adherent sheet and an ink display zone (16).

This embodiment of the device is typically used for the treatment of termite infestations, for which termite bait is used. The termiticide dust (28) is a free flowing form and a discrete amount of it is inserted or “puffed” into a drilled hole and/or termite workings using a hand bulb duster in the usual manner. The termiticide dust (28) typically coats the internal surface of the hole, as shown in FIG. 7.

In use, the bait presenting device (10) is applied or adhered to the a surface surrounding the hole into which the termiticide dust (28) has been inserted, thereby enclosing the dust in the hole. This step is repeated to cover all the holes into which bait has been inserted. The device (10) acts as a bung which substantially reduces the airflow into the hole and thus the termite workings (not shown) so that termites are less likely to avoid the point of treatment.

### EXAMPLE 6

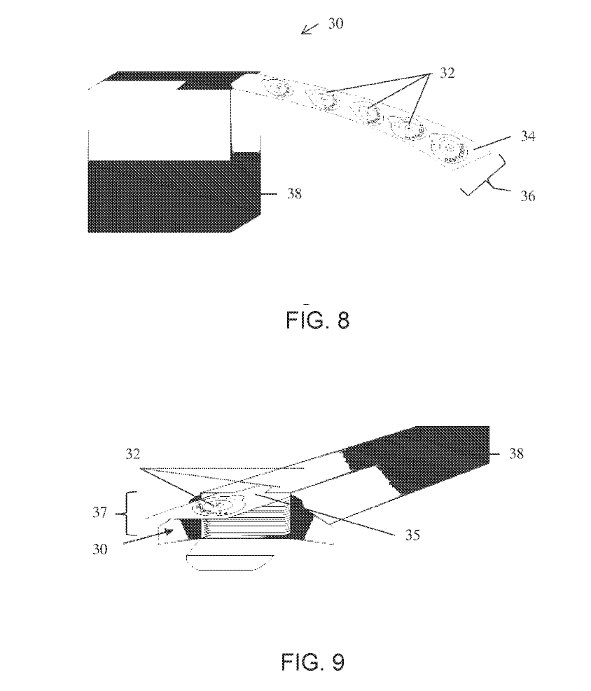

FIG. 8 shows a seventh embodiment of the invention, which provides a kit (30) comprising a plurality of bait presenting devices (32) which are adhered to a backing sheet (34) in a continuous strip (36). The strip (36) is packed as a compact roll, and dispensed from a box (38), such as a cardboard box, in the typical adherent sheet fashion.

### EXAMPLE 7

FIG. 9 shows an eighth embodiment of the invention, which provides a kit (30) comprising a plurality of bait presenting devices (32) adhered to a series of backing sheets (35). The stacked series of backing sheets (35) is packed in a box (38), such as a cardboard box.

It will be apparent to those skilled in the art that many other embodiments of a bait presenting device exist which fall within the scope of the invention. It should also be apparent that the bait presenting device may be manufactured by any suitable processes such as, for example, by conventional adherent sheet manufacturing technology using materials suitable for use in the invention. The invention provides a convenient way of providing an insect bait station which can be used in conjunction with commercially available baits and bait gels, while assuring the user that the devices are safely located and that they can be easily monitored. It will be appreciated that a combination of different embodiments of the invention may be used to provide a range of bait gel doses throughout a single area.

The bait presenting device of the invention provides an alternative to conventional bait stations. The bait presenting device of the invention is relatively smaller in size and more attractive in appearance than many bait stations that are currently available. Importantly, they have the advantage of being easily detectable by a user which makes them easy to find when it is time to dispose of them. Since the bait displayed on the bait presenting device is comparatively smaller in size and visible, it is easier for a user to monitor whether the bait has been consumed by insects, and whether it needs replacement. In addition, the bait presenting device can be used on many types of surfaces without causing damage to the surface, and may be reapplied for reuse without causing damage to the bait presenting device. The device of the invention may be applied at any angle and may therefore be applied not only to horizontal surfaces, but also to vertical surfaces. The devices do not make use of any tacky surfaces for the capture of insects, such as those used in many currently available bait stations, such that the bait remains accessible to insects without the build up debris from dust and dead insects blocking access to the bait surface, increasing its effectiveness. The device substantially reduces and/or minimises any stains and/or damage to the surfaces which would have been caused by direct contact with the bait gel. The device of the invention may be printed in a bright colour so that it is clearly visible and recognisable and the bait gel applied to the adherent sheet is less likely to be mistaken for dirt and grime and inadvertently removed.

In addition, the device provides a measurement guide to guide a user in easily applying an accurate, uniform, and repeatable dose to a surface. This reduces waste of the bait gel and makes it easier for a user to record the starting dose so as to monitor any later consumption of bait gel.

The method and device of the invention may be used together with many different kinds of bait, and different doses, so that a pest treatment plan may be customised and monitored for a particular infestation. In this way, a user can determine the effectiveness of different baits and/or doses, and adapt a pest treatment plan accordingly.

The device of the invention is typically made from a polymer which has the advantage of preventing the loss of moisture from the baits into the surface to which the device has been applied. This increases the longevity of the bait.

In circumstances when it is not yet clear whether an infestation exists which requires treatment, it may be undesirable to use toxic bait. The method and device of the invention may be used to monitor potential consumption of non-toxic bait by possible insects, in order to first establish whether insects are present and whether they are attracted to the bait. The invention gives a user the option of first applying non-toxic bait in areas where food is prepared for consumption by humans, to establish whether or not an insect infestation exists.

When used to treat termite infestations, the method and device may be used to enclose holes (such as drilled holes) in timbers, furniture and the like, into which termite treatment chemicals and bait have been inserted. The devices and methods of the invention have the advantage of substantially preventing airflow into the holes. The reduction of airflow into the holes, reduces the movement of air into the workings so that termites are less likely to avoid the point of treatment, thereby maximising the effectiveness of the treatment. The devices facilitate the easy detection of treatment holes by users, as well as informing users of the nature of the termite treatment underway.

Where the terms “include”, “includes”, “included” or “including”, “comprise”, “comprises”, “comprised” or “comprising” are used in this specification, they are to be interpreted as specifying the presence of the stated features, integers, steps or components referred to, but not to preclude the presence or addition of one or more other feature, integer, step, component or group thereof.

Any prior art reference or statement provided in the specification is not to be taken as an admission that such art constitutes, or is to be understood as constituting, part of the common general knowledge.

1-36. (canceled)

37. A substantially planar bait presenting device comprising
a bait contact zone for receiving bait wherein the bait contact zone comprises a dose measurement guide; and
an ink display zone.

38. The device according to claim 37, wherein the bait contact zone and the ink display zone are adjacently disposed on an adherent sheet comprising a printable sheet and an adherent layer.

39. The device according to claim 37, wherein the dimensions of the dose measurement guide are configured to receive a predetermined dose of bait.

40. The device according to claim 38, wherein the bait contact zone is disposed on an operative upper surface of the device, and the adherent layer is disposed on an operative lower surface of the device.

41. The device according to claim 38, wherein the bait contact zone and the adherent layer are disposed on an operative lower surface of the device.

42. The device according to claim 37, wherein:
a) the dose measurement guide comprises:
i) indicia defining an area corresponding to a predetermined dose of bait; and/or
ii) a raised perimeter which substantially defines a well for receiving bait; and/or
b) the device further comprises a tab; and/or
c) the ink display zone comprises visual indicia.

43. The device according to claim 42, wherein the visual indicia comprise fluorescent ink or pigment.

44. The device according to claim 37, wherein the bait contact zone further comprises bait.

45. The device according to claim 44, wherein the bait contains pesticide.

46. The device according to claim 44, wherein the bait is in the form of bait gel or a solid bait.

47. The device according to claim 38, wherein the adherent layer comprises a non-permanent adhesive or electrostatic film.

48. The device according to claim 38, wherein the printable sheet comprises a plastic polymer or polypropylene material.

49. A kit comprising a plurality of bait presenting devices according to claim 37, and a backing sheet to which the devices are removably adhered.

50. The kit according to claim 49, wherein the plurality of bait presenting devices are adhered to a backing sheet in a continuous strip.

51. A method of displaying bait, the method comprising the steps of:
adhering a device according to claim 37 to a surface; and
applying a discrete amount of bait to the bait contact zone.

52. The method of claim 51, wherein the step of applying a discrete amount of bait to the bait contact zone comprises applying the bait until the area defined by the dose measurement guide is substantially covered with bait.

53. The method of claim 51, wherein the method comprises displaying a predetermined dose of bait.

54. The method according claim 51, wherein the bait contains pesticide.
